(19) United States
(12) Patent Application Publication
(10) Pub. No.: US 2010/0150257 A1
(43) Pub. Date: Jun. 17, 2010

(54) APPARATUS AND METHOD FOR ESTIMATING TIMING OFFSET IN A WIRELESS COMMUNICATION SYSTEM

(75) Inventors: Il-Gu Lee, Seoul (KR); Hun-Sik Kang, Daejon (KR); Sok-Kyu Lee, Daejon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: Electronics and Telecommunications Research Institute, Daejon (KR)

(21) Appl. No.: 12/556,023

(22) Filed: Sep. 9, 2009

(30) Foreign Application Priority Data
Dec. 11, 2008 (KR) 10-2008-0125782

(51) Int. Cl. H04L 7/00; H04L 27/28; H04B 15/00

(52) U.S. Cl. 375/260; 375/285; 375/371

(57) ABSTRACT

A method for estimating timing offset in an OFDM wireless communication system using preamble and pilot includes: estimating a carrier offset by using preamble included in a currently received OFDM packet and estimating a first timing offset based on the estimated carrier offset to thereby produce a first timing offset estimation value; estimating a second timing offset to thereby produce a second timing offset estimation value by transforming the OFDM packet into signals of frequency domain and using a pilot signal of the frequency-domain signals; checking a channel condition based on packet error information of a previously received packet to thereby produce error condition information, and selecting one between the first timing offset estimation value and the second timing offset estimation value based on the error condition information; and compensating data signals for timing offset among the frequency-domain signals the based on the selected timing offset estimation value.

### CROSS-REFERENCE TO RELATED APPLICATIONS

The present invention claims priority of Korean Patent Application No. 10-2008-0125782, filed on Dec. 11, 2008, which is incorporated herein by reference.

### BACKGROUND OF THE INVENTION

1. Field of the Invention

The present invention relates to an apparatus and method for estimating offset of data; and, more particularly, to an apparatus and method for estimating timing offset of data received in a wireless communication system

2. Description of Related Art

Wireless communication systems have developed from voice-based mobile communication systems to current diverse forms of wireless communication system capable of providing high-speed data services. Such high-speed data services are originated from the increasing demand for high-speed multimedia contents. Many researchers are studying to provide high-speed data services in the wireless communication systems.

For example, researchers are studying to increase a data rate in a physical (PHY) layer and increase a throughput in a Media Access Control (MAC) layer.

Hereafter, methods for increasing a data rate in a PHY layer will be described. To increase a data rate in a PHY layer, a wide variety of technologies such as Multiple Input Multiple Output (MIMO) antenna technology, Orthogonal Frequency Division Multiplexing (OFDM) technology, high modulation technology, use of broad bandwidth, use of high code rate channel CODEC, use of a short guard interval and so forth, are used in combinations.

Next, a method for increasing a throughput in an MAC layer will be described. The throughput in an MAC layer is related to a speed that a system user perceives. Throughput is calculated by dividing the length of a successfully transmitted packet by the time taken to transmit the packet. Therefore, overhead time other than the time that the packet occupies a channel should be reduced to increase the throughput. Recently, a method of using aggregation and a block ack to secure a channel occupying right for a predetermined time, transmitting packets consecutively for the predetermined time, and transmitting an ack signal only once for a packet with an error is used to reduce the overhead. As described above, the packet aggregation and block ack technology is used in an MAC layer to reduce overhead caused by the interval among preamble, header and packets.

An example of systems using such technologies is IEEE 802.11n. To have a close look at the method used in the IEEE 802.11n, the data rate of a PHY layer is improved up to around 300 Mbps by transmitting signals through two streams based on 64-QAM, a code rate of 5/6, and a bandwidth of around 40 MHz at an interval of around 400 ns. Also, the aggregation and block ack technology is used in an MAC layer to thereby make it possible to support throughput over abound 200 Mbps. As described above, the designing of the high-speed wireless communication system is focused on two important things. One is to have the maximum data rate and throughput in a near area where a channel is stable and has an excellent signal-to-noise ratio (SNR). The other is to maximally widen a reaching range by minimally reducing a PHY data rate when the signal-to-noise ratio is poor due to long distance. In other words, when channel conditions are fine, an excellent high-speed wireless communication system should be able to transmit signals at a maximal data rate the system can afford. When the channel conditions are poor, the reaching range should be secured sufficiently by decreasing the data rate and thereby increasing reliability.

A receiving block of a general wireless communication system is equipped with a device for compensating for signal distortion by an analog element and influence by a varying channel. The receiving block includes a timing offset compensation block to compensate for the influence of a clock phase difference between a transmitting block and the receiving block. According to conventional method used up until now, the receiving block separately includes a pilot-based timing offset compensating device and a preamble-based timing offset compensating device.

As described above, the aggregation and block ack technology can increase the throughput as it can transmit long packets for a channel occupying period in an MAC layer. However, the aggregation and block ack technology also has a problem in that errors propagate due to the long packet length. Low signal-to-noise ratio also greatly affects the error propagation because an offset estimation value obtained based on a pilot in a long packet duration is inaccurate. Conversely, high signal-to-noise ratio decreases performance because a timing offset estimated based on a preamble-based carrier frequency offset (CFO) is realized as a fixed decimal point and a small error propagates.

### SUMMARY OF THE INVENTION

An embodiment of the present invention is directed to providing an apparatus and method for adaptively deciding a timing offset according to a signal-to-noise ratio.

Another embodiment of the present invention is directed to providing an apparatus and method for preventing a transmission performance from being deteriorated due to an error of an estimated timing offset.

Another embodiment of the present invention is directed to providing an apparatus and method for reducing an error of a timing offset according to a packet length.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided an apparatus for estimating a timing offset in an orthogonal Frequency Division Multiplexing (OFDM) wireless communication system using a preamble and a pilot, the apparatus including: a first timing offset estimator for estimating a carrier offset by using a preamble included in a packet currently received based on an OFDM method and estimating a first timing offset based on the estimated carrier offset to thereby produce a first timing offset estimation value; a second timing offset estimator for estimating a second timing offset to thereby produce a second timing offset estimation value by transforming the OFDM packet into signals of a frequency domain and using a pilot signal of the frequency-domain signals; a multiplexer for selectively outputting the first timing offset estimation value and the second timing offset estimation value based on a control signal; a timing offset compensator for compensating data signals for a timing offset among the frequency-domain signals based on the output from the multiplexer; and a controller for checking a channel condition based on packet error information of a previously received packet to thereby produce error condition information and outputting the control signal based on the error condition information.

In accordance with another aspect of the present invention, there is provided a method for estimating a timing offset in an Orthogonal Frequency Division Multiplexing (OFDM) wireless communication system using a preamble and a pilot, the method including: estimating a carrier offset by using a preamble included in a packet currently received based on an OFDM method and estimating a first timing offset based on the estimated carrier offset to thereby produce a first timing offset estimation value; estimating a second timing offset to thereby produce a second timing offset estimation value by transforming the OFDM packet into signals of a frequency domain and using a pilot signal of the frequency-domain signals; checking a channel condition based on packet error information of a previously received packet to thereby produce error condition information, and selecting one between the first timing offset estimation value and the second timing offset estimation value based on the error condition information; and compensating data signals for a timing offset among the frequency-domain signals based on the selected timing offset estimation value.

### BRIEF DESCRIPTION OF THE DRAWINGS

FIG. 1 is a block diagram showing an internal function of a receiver in accordance with an embodiment of the present invention.

FIG. 2 is a flowchart describing a process of deciding a timing offset adaptively to a channel in accordance with an embodiment of the present invention.

FIG. 3 is a simulation graph showing a relationship between a packet error rate (PER) and a signal-to-noise ratio (SNR) when an adaptive timing offset estimating apparatus according to an embodiment of the present invention is used.

FIG. 4 is a graph showing a simulated performance based on the result of FIG. 3.

### DESCRIPTION OF SPECIFIC EMBODIMENTS

The advantages, features and aspects of the invention will become apparent from the following description of the embodiments with reference to the accompanying drawings, which is set forth hereinafter. If a part to be described is obvious to those skilled in the art to which the present invention pertains, the description of the part will be omitted in order not to obscure a point of the present invention. Also, terms used hereafter are used only to help understanding the present invention and diverse terms may be used for each manufacturer or a research group although the usage is the same.

Generally, a system employing an aggregation method estimates and compensates for a timing offset based on a pilot or a preamble regardless of channel conditions. According to the method, when a signal-to-noise ratio (SNR) is poor, an estimation value for a pilot-based timing offset becomes inaccurate and thus an estimation error increases as it goes to the end of a long packet, and eventually, the packet becomes an error packet. On the other hand, a preamble-based timing offset estimation makes a relatively accurate estimation because a preamble has more iterative sequences than a pilot. Therefore, when the signal-to-noise ratio is low, the performance of the preamble-based timing offset estimation is better than that of the pilot-based timing offset estimation. However, in case that the signal-to-noise ratio is high, the performance of the pilot-based timing offset estimation becomes better than the preamble-based timing offset estimation. The reason is as follows. The fine signal-to-noise ratio makes the initial estimation values of the pilot-based timing offset and the preamble-based timing offset the same. However, since a pilot comes between data fields whereas a preamble exists only in the initial part of a packet, errors propagate and increase in case of the preamble-based timing offset estimation as it goes to the end of a packet. Under the same circumstances, the pilot-based timing offset estimation is superior to the preamble-based timing offset estimation because an estimation value is updated based on a pilot value included in a data field.

Since the two methods have the above-described performance difference, the present invention uses both pilot-based timing offset estimation and preamble-based timing offset estimation adaptively to channel conditions, and after all the present invention provides an apparatus and method that can improve a reaching range and throughput.

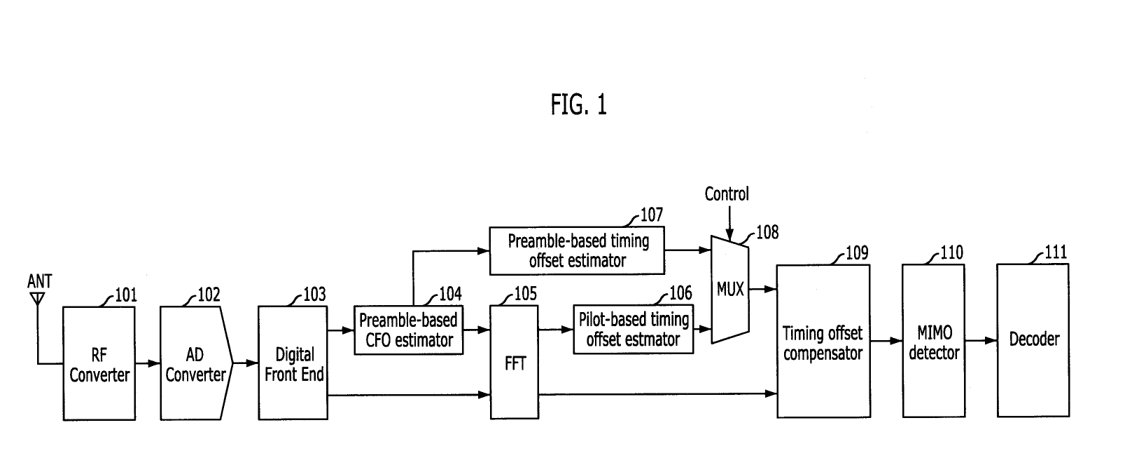

FIG. 1 is a block diagram showing an internal function of a receiver in accordance with an embodiment of the present invention. FIG. 1 illustrates a receiver of an 802.11n-based system employing an Orthogonal Frequency Division Multiplexing (OFDM) and using both preamble and pilot. The present invention, however, can be applied to all systems using an OFDM scheme, a preamble, and/or a pilot. For example, the present invention is applicable to a Digital Multimedia Broadcasting (DMB) system, a Wireless Broadband (WiBro) system, or a Wimax system.

A signal received through an antenna (ANT) is inputted to a radio frequency (RF) converter 101. The RF converter 101 converts the inputted RF signal into a baseband signal. The conversion into the baseband signal may be performed using a widely known superheterodyne method or a direct conversion method. The baseband signal, which is an analog signal, is inputted to an analog-to-digital converter (ADC) 102. The analog-to-digital converter 102 converts the received analog baseband signal into a digital signal. The digital signal is inputted to a digital front-end 103. The digital front-end 103 compensates for signal distortion caused by a channel and an analog device and outputs a compensated signal. Herein, the digital front-end 103 outputs a preamble signal among received signals to a preamble-based carrier frequency offset (CFO) estimator 104, and outputs the other signals except for the preamble to a Fast Fourier Transformer (FFT) 105.

First, the preamble-based CFO estimator 104 estimates and outputs a carrier frequency offset based on a preamble signal. The estimated carrier frequency offset is inputted to the FFT 105 and a preamble-based CFO timing offset estimator 107. The preamble-based CFO timing offset estimator 107 estimates a timing offset by using a CFO value estimated based on a preamble.

Meanwhile, the FFT 105 converts received time-domain data into frequency-domain signals based on the carrier frequency offset value inputted from the preamble-based CFO estimator 104. Herein, the FFT 105 extracts a pilot signal out of the frequency-domain signals. The extracted pilot signal is inputted to a pilot-based timing offset estimator 106. Also, data except the pilot signal among signals obtained from fast Fourier transform are inputted to a timing offset compensator 109 as frequency-domain data.

The pilot-based timing offset estimator 106 estimates and outputs a value obtained from the fast Fourier transform, that is, a timing offset value, by using a pilot signal in the frequency domain. Then, a timing offset value estimated based on CFO, which is also estimated based on a preamble, and a timing offset value estimated based on a pilot signal are inputted to a multiplexer 108. The multiplexer 108 selects any one signal between the two signals under the control of a controller (not shown in FIG. 1) and outputs the selected signal. The controller applies a control signal to the multiplexer 108 so that the multiplexer 108 selects and output any one between the timing offset values, which are estimated based on the preamble and the pilot, that is, which are estimated in the time domain and the frequency domain, respectively. The controller generates the control signal based on the following conditions.

Channel conditions are estimated based on the state of a previously received frame and it is decided first whether the conditions of the estimated channel are fine or not. Processes following the fine and poor conditions of the estimated channel will be described later with reference to a control flowchart. When the estimated channel is decided to be in fine conditions, the controller performs control for the multiplexer 108 to output the output of the pilot-based timing offset estimator 106. On the contrary, when the estimated channel is decided to be in poor conditions, the controller performs control for the multiplexer 108 to output the output of the preamble-based timing offset estimator 107. Herein, the controller decides the output switching in the multiplexer 108 on a packet basis.

A timing offset compensator 109 receives a timing offset value outputted from the multiplexer and compensates for a timing offset based on the received data and timing offset value. A signal obtained after timing offset compensation is recovered into the signal transmitted from a transmitter. FIG. 1 illustrates a system using multiple antennas. Regardless of the presence of an MIMO detector 110, if a system uses a single antenna, the system may not include an MIMO detector 110. A signal detected in the MIMO detector 110 is inputted to a decoder 111. The decoder 111 performs channel decoding onto the inputted signal and outputs a decoded signal. Such channel decoder is determined according to a coding method of the system, such as a convolutional decoder, a turbo decoder, Viterbi decoder, or a Low Density Parity Check (LDPC) decoder. In the present invention, there is no specific limitation in the kind of the decoder.

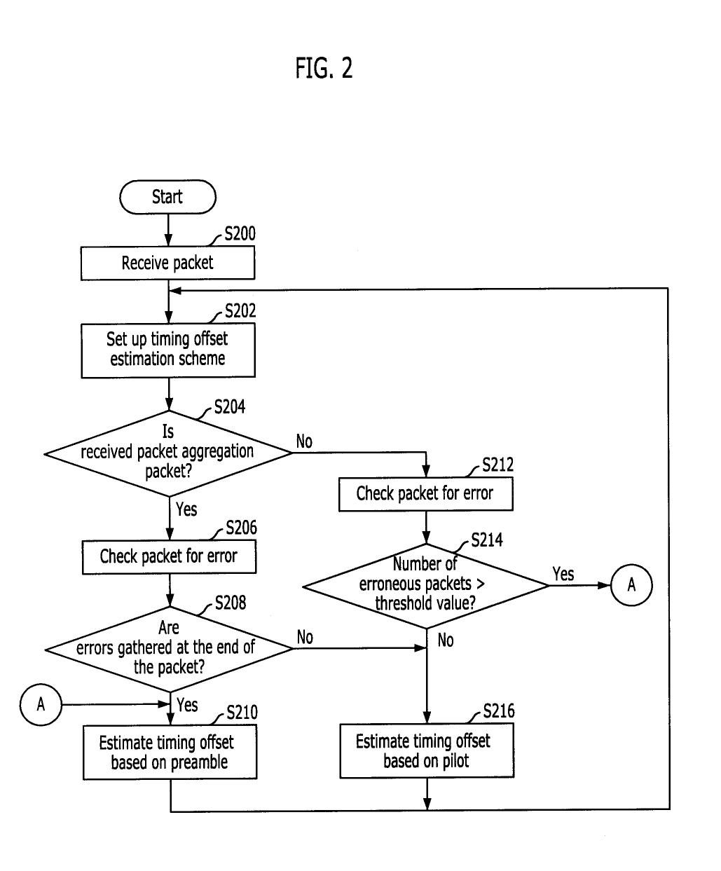

FIG. 2 is a flowchart describing a process of deciding a timing offset adaptively to a channel in accordance with an embodiment of the present invention.

At step S200, a packet is received, and a controller establishes a timing offset estimation method at step S202. When the packet is the initially received packet, the controller may decide a predetermined timing offset estimation method as the timing offset estimation method or it may periodically check channel conditions and decide the timing offset estimation method based on the channel conditions. If the packet is one inputted after the input of the initial packet, it continues to use the timing offset estimation method decided before.

When the timing offset estimation method is decided, the controller checks whether a current packet is an aggregation packet at step S204. As described in the section of background technology, an aggregation packet is a packet designed to transmit a plurality of packets at one time. When the received packet is an aggregation packet, the controller proceeds to step S206. Otherwise, if the received packet is not an aggregation packet, the controller proceeds to step S212.

First, a process through the step S206 will be described hereafter. The controller checks whether there is an error in the aggregation packet received at the step S206. What is included in the packet error check are the number, position, and distribution of erroneous packets among the packets distributed in the received aggregation packet.

After the packet error check, the controller checks whether the distribution of the errors are concentrated in the tail of the aggregation packet at step S208. Concentrated distribution of the errors in the tail of the aggregation packet signifies that the signal-to-noise ratio is low and thus the channel is in poor conditions.

In this case, it is appropriate to use a preamble-based timing offset estimation method. Therefore, the controller decides to estimate a timing offset by using a preamble at step S210, and performs control to output a control signal in such a manner that a signal whose timing offset is estimated based on a CFO, which is also estimated based on a preamble, is used for offset compensation.

Meanwhile, when the received packet is not an aggregation packet, the controller performs an error packet check at step S212. Herein, the error packet check means checking the number of packets with errors for a predetermined time or a predetermined packet duration. At step S214, the controller checks whether the counted number of erroneous packets is greater than a predetermined threshold value. At the step S214, when the number of erroneous packets is greater than the predetermined threshold value, the logic flow goes to step S216. When the number of erroneous packets is equal to or smaller than the predetermined threshold value, the logic flow goes to step S210.

The logic flowing from the step S208 or the step S214 to the step S216 signifies that the signal-to-noise ratio is high. Therefore, it is appropriate to a pilot-based timing offset estimation method. Thus, the controller decides to use the pilot-based timing offset estimation method at step S216.

According to the present invention described above, reaching range and throughput can be improved by selecting any one between the preamble-based timing offset estimation method and the pilot-based timing offset estimation method according to channel conditions. Consequently, when the channel conditions are poor, the reaching range can be broadened by performing timing offset compensation based on a preamble to increase the reliability of an estimation value. When the channel conditions are fine, the throughput can be improved by performing timing offset compensation based on a pilot to minimize an error propagation effect of a long packet. Ultimately, these methods secure users with quality of service.

The present invention employs two timing offset estimators. The advantages and disadvantages of the two timing offset estimators are as follows. The preamble-based timing offset estimation method using a CFO estimation value shows superior performance at a low signal-to-noise ratio to the pilot-based timing offset estimation method. However, in the preamble-based timing offset estimation method, the CFO is estimated based on an RF center frequency. Therefore, a scaling factor should be modified according to the RF center frequency whenever the RF center frequency changes. Also, since the CFO estimation is realized in hardware to a fixed decimal point, a minute error may occur. The minute error occurring in the process may bring about errors occurring at the end of a packet in case of a long packet having many symbols.

At a high signal-to-noise ratio, a preamble-based CFO estimator should multiply a different scaling factor at every different RF center frequency and it has an error propagation caused by an error expressed by a fixed decimal point. On the contrary, although the pilot-based timing offset estimation method shows poor characteristics at a low signal-to-noise ratio, it has a relatively small influence of an error propagation or the scaling factor according to the center frequency because it estimates an error in the frequency domain based on a pilot of each data field.

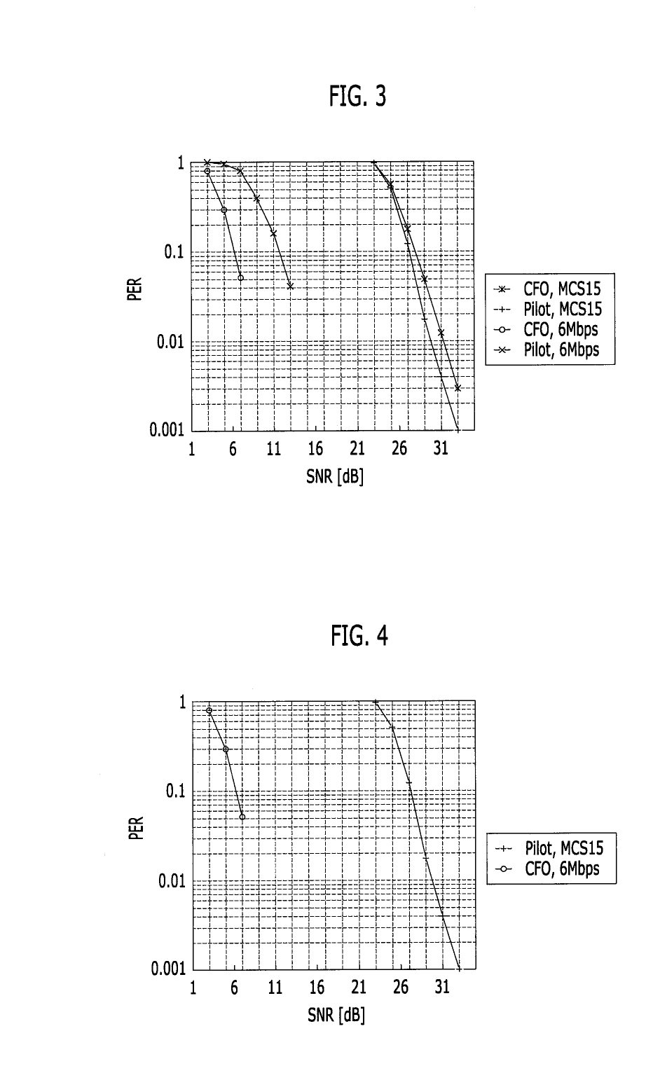

FIG. 3 is a simulation graph showing a relationship between a packet error rate (PER) and a signal-to-noise ratio (SNR) when an adaptive timing offset estimating apparatus according to an embodiment of the present invention is used.

The simulation of FIG. 3 was operated by using a wireless Local Area Network (LAN) system which supports 270 Mbps in an MCS15 mode having a code rate of 5/6 based on 64-QAM in an interior environment of a 50 ns RMS delay spread channel. Also, it shows simulation results of packet error rates according to varying signal-to-noise ratio in a case of 6 Mbps having a code rate of 1/2 based on BPSK by using the pilot-based timing offset estimation method and the preamble-based timing offset estimation method employing a CFO estimation value. In FIG. 3, ‘*’ denotes a case of using the preamble-based timing offset estimation method in MCS15, whereas ‘+’ denotes a case of using the pilot-based timing offset estimation method in MCS15. ‘∘’ denotes a case of using a preamble-based timing offset estimation method in 6 Mbps mode, whereas ‘×’ denotes a packet error rate of a case using the pilot-based timing offset estimation method in 6 Mpbs.

The simulation results of FIG. 3 show that the signal-to-noise ratio required to achieve 10% of PER is 6 dB in case of using the preamble-based timing offset estimation method in 6 Mbps, and the signal-to-noise ratio required to achieve 10% of PER is around 11.5 dB, which is higher by around 5.5 dB, in case of using the pilot-based timing offset estimation method. On the contrary, in case of MCS15, the pilot-based timing offset estimation method shows a signal-to-noise ratio of 27 dB whereas the preamble-based timing offset estimation method shows a signal-to-noise ratio of 28 dB, which is higher by around 1 dB. The simulation results show that when a timing offset estimation method is fixed to any one between the two estimation methods, the performance may deteriorate at low signal-to-noise ratio or high signal-to-noise ratio. Since the present invention performs switching between the two timing offset methods according to a signal-to-noise ratio, it is possible to perform efficiently.

FIG. 4 is a graph showing a simulated performance based n the result of FIG. 3. As shown in the drawing, a signal-to-noise ratio is decided based on the magnitude of a received signal or the number of successfully received ack packets.

The receiving apparatus of the present invention can adaptively decide a timing offset according to a signal-to-noise ratio, prevent transmission performance from being deteriorated due to an error of an estimated timing offset, and decrease an error of a timing offset according to a packet length.

While the present invention has been described with respect to the specific embodiments, it will be apparent to those skilled in the art that various changes and modifications may be made without departing from the spirit and scope of the invention as defined in the following claims.

What is claimed is:

1. A method for estimating a timing offset in an Orthogonal Frequency Division Multiplexing (OFDM) wireless communication system using a preamble and a pilot, comprising:
estimating a carrier offset by using a preamble included in a packet currently received based on an OFDM method and estimating a first timing offset based on the estimated carrier offset to thereby produce a first timing offset estimation value;
estimating a second timing offset to thereby produce a second timing offset estimation value by transforming the OFDM packet into signals of a frequency domain and using a pilot signal of the frequency-domain signals;
checking a channel condition based on packet error information of a previously received packet to thereby produce error condition information, and selecting one between the first timing offset estimation value and the second timing offset estimation value based on the error condition information; and
compensating data signals for a timing offset among the frequency-domain signals based on the selected timing offset estimation value.

2. The method of claim 1, wherein said estimating a carrier offset by using a preamble included in a packet currently received based on the OFDM method and estimating a first timing offset based on the estimated carrier offset to thereby produce a first timing offset estimation value includes:
estimating a carrier frequency offset based on the preamble included in the packet currently received in the OFDM method; and
estimating a timing offset of a packet based on the estimated carrier frequency offset.

3. The method of claim 1, wherein said estimating a second timing offset to thereby produce a second timing offset estimation value by converting the OFDM packet into a signal of a frequency domain and using a pilot signal of the frequency-domain signal includes:
performing fast Fourier transform and transforming the packet currently received in the OFDM method into frequency-domain signals; and
estimating a timing offset based on a pilot signal among the frequency-domain signals.

4. The method of claim 3, wherein in said checking a channel condition based on packet error information of a previously received packet to thereby produce error condition information, and selecting any one between the first timing offset estimation value and the second timing offset estimation value based on the error condition information includes,
when packets received prior to the current packet are single packets and the number of errors occurring for a predetermined packet duration is equal to or greater than a threshold value, the first timing offset estimation value is selected.

5. The method of claim 3, wherein in said checking a channel condition based on packet error information of a previously received packet to thereby produce error condition information, and selecting any one between the first timing offset estimation value and the second timing offset estimation value based on the error condition information includes,
when packets received prior to the current packet are single packets and the number of errors occurring for a predetermined packet duration is smaller than a threshold value, the second timing offset estimation value is selected.

6. The method of claim 3, wherein in said checking a channel condition based on packet error information of a previously received packet to thereby produce error condition information, and selecting any one between the first timing offset estimation value and the second timing offset estimation value based on the error condition information includes,
when a packet received prior to the current packet is an aggregation packet, whether the number of errors existing in the tail of the aggregation packet is equal to or greater than a predetermined value is checked, and if the number of errors in the tail of the aggregation packet is equal to or greater than the predetermined number, the first timing offset estimation value is selected.

7. The method of claim 3, wherein in said checking a channel condition based on packet error information of a previously received packet to thereby produce error condition information, and selecting any one between the first timing offset estimation value and the second timing offset estimation value based on the error condition information includes,
when a packet received prior to the current packet is an aggregation packet, whether the number of errors existing in the last packet of the aggregation packet is equal to or greater than a predetermined value is checked, and if the number of errors in the tail of the aggregation packet is smaller than the predetermined number, the second timing offset estimation value is selected.

8. An apparatus for estimating a timing offset in an Orthogonal Frequency Division Multiplexing (OFDM) wireless communication system using a preamble and a pilot, comprising:
a first timing offset estimator for estimating a carrier offset by using a preamble included in a packet currently received based on an OFDM method and estimating a first timing offset based on the estimated carrier offset to thereby produce a first timing offset estimation value;
a second timing offset estimator for estimating a second timing offset to thereby produce a second timing offset estimation value by transforming the OFDM packet into signals of a frequency domain and using a pilot signal of the frequency-domain signals;
a multiplexer for selectively outputting the first timing offset estimation value and the second timing offset estimation value based on a control signal;
a timing offset compensator for compensating data signals for a timing offset among the frequency-domain signals based on the output from the multiplexer; and
a controller for checking a channel condition based on packet error information of a previously received packet to thereby produce error condition information and outputting the control signal based on the error condition information.

9. The apparatus of claim 8, wherein the first timing offset estimator includes:
a carrier frequency offset estimator for estimating a carrier frequency offset based on the preamble included in the packet currently received in the OFDM method; and
a preamble-based timing offset estimator for estimating a timing offset of a packet based on the estimated carrier frequency offset.

10. The apparatus of claim 8, wherein the second timing offset estimator includes:
a fast Fourier transformer (FFT) for transforming the packet currently received in the OFDM method into frequency-domain signals; and
a pilot-based timing offset estimator for estimating a timing offset based on a pilot signal among the frequency-domain signals.

11. The apparatus of claim 10, wherein when packets received prior to the current packet are single packets and the number of errors occurring for a predetermined packet duration is equal to or greater than a threshold value,
the controller generates the control signal to be outputted to the multiplexer in such a manner that the output of the first timing offset estimator is sent to the timing offset compensator.

12. The apparatus of claim 10, wherein when packets received prior to the current packet are single packets and the number of errors occurring for a predetermined packet duration is smaller than a threshold value,
the controller generates the control signal to be outputted to the multiplexer in such a manner that the output of the second timing offset estimator is sent to the timing offset compensator.

13. The apparatus of claim 10, wherein when a packet received prior to the current packet is an aggregation packet, whether the number of errors existing in the tail of the aggregation packet is equal to or greater than a predetermined value is checked, and if the number of errors in the tail of the aggregation packet is equal to or greater than the predetermined number,
the controller generates the control signal in such a manner that the output of the first timing offset estimator is sent to the timing offset compensator.

14. The apparatus of claim 10, wherein when a packet received prior to the current packet is an aggregation packet, whether the number of errors existing in the tail of the aggregation packet is equal to or greater than a predetermined value is checked, and if the number of errors in the tail of the aggregation packet is smaller than the predetermined number,
the controller generates the control signal in such a manner that the output of the second timing offset estimator is sent to the timing offset compensator.
